(19) United States
(12) Patent Application Publication
(10) Pub. No.: US 2011/0229761 A1
(43) Pub. Date: Sep. 22, 2011

(54) INTERCONNECTING ELECTROCHEMICALLY ACTIVE MATERIAL NANOSTRUCTURES

(75) Inventors: Yi Cui, Stanford, CA (US); Song Han, Foster City, CA (US); Ghyrn E. Loveness, Menlo Park, CA (US); Rainer Fasching, Mill Valley, CA (US); William S. DelHagen, Menlo Park, CA (US); Eugene M. Berdichevsky, Menlo Park, CA (US)

(73) Assignee: AMPRIUS, INC., Menlo Park, CA (US)

(21) Appl. No.: 13/069,212

(22) Filed: Mar. 22, 2011

Related U.S. Application Data
(60) Provisional application No. 61/316,104, filed on Mar. 22, 2010.

(51) Int. Cl. H01M 4/58; B05D 5/12

(52) U.S. Cl. 429/218.1; 427/78

(57) ABSTRACT

Provided are various examples of lithium electrode subassemblies, lithium ion cells using such subassemblies, and methods of fabricating such subassemblies. Methods generally include receiving nanostructures containing electrochemically active materials and interconnecting at least a portion of these nanostructures. Interconnecting may involve depositing one or more interconnecting materials, such as amorphous silicon and/or metal containing materials. Interconnecting may additionally or alternatively involve treating a layer containing the nanostructures using various techniques, such as compressing the layer, heating the layer, and/or passing an electrical current through the layer. These methods may be used to interconnect nanostructures containing one or more high capacity materials, such as silicon, germanium, and tin, and having various shapes or forms, such as nanowires, nanoparticles, and nano-flakes.

### CROSS-REFERENCE TO RELATED APPLICATIONS

This application claims the benefit of U.S. Provisional Application No. 61/316,104, filed Mar. 22, 2010, entitled “INTERCONNECTING ACTIVE MATERIAL NANOSTRUCTURES,” which is incorporated herein by reference in its entirety for all purposes.

### BACKGROUND

The demand for high capacity rechargeable batteries is strong. Many applications, such as aerospace, medical devices, portable electronics, and automotive applications, require high gravimetric and/or volumetric capacity cells. Lithium ion electrode technology provided some improvements in this area. However, to date, lithium ion cells are predominantly fabricated with negative electrodes containing graphite, which has a theoretical capacity of only 372 mAh/g.

Silicon, germanium, tin, and many other materials are attractive active materials because of their high electrochemical capacity. For example, silicon has a theoretical capacity of about 4200 mAh/g, which corresponds to its Li_{4.4}Si lithiation phase. Yet, many of these materials are not widely used in commercial lithium ion batteries. One reason is that some of these materials exhibit substantial changes in volume during lithiation. For example, silicon swells by as much as 400% when charged to its theoretical capacity. Volume changes of this magnitude can cause substantial stresses in the active material structures resulting in fractures and pulverization, loss of electrical and mechanical connections within the electrode, and capacity fading.

Furthermore, conventional electrodes include polymer binders to support active materials on the substrate. However, most polymer binders are not sufficiently elastic to accommodate large changes in volume of some high capacity materials. As a result, active material particles tend to separate from each other and the current collector resulting in capacity fading. Overall, there is a need for improved applications of high capacity active materials in battery electrodes that minimize various drawbacks described above. These and other features will be further described below with reference to the specific drawings.

### SUMMARY

Provided are various examples of lithium electrode subassemblies, lithium ion cells using such subassemblies, and methods of fabricating subassemblies and cells. Fabrication methods generally include receiving nanostructures that contain one or more electrochemically active materials and interconnecting at least a portion of these nanostructures by depositing one or more interconnecting materials. Examples of interconnecting materials include various semiconductor containing materials and/or metal containing materials. For example, amorphous silicon or germanium, copper, nickel, silicides, and other materials can be used for such purposes. In certain embodiments, nanostructures are directly interconnected without any other materials by, for example, applying pressure, temperature, and/or electrical current to a layer formed by the nanostructures. These techniques can be used to interconnect nanostructures containing one or more high capacity materials, such as silicon, germanium, and tin.

In certain embodiments, a method of fabricating a lithium ion electrode subassembly for use in a lithium ion cell involves receiving nanostructures comprising an electrochemically active material and depositing amorphous silicon and/or germanium over the nanostructures to electrically interconnect at least a portion of the nanostructures. Examples of the electrochemically active material include silicon, germanium, tin, and combinations thereof. Other active materials may be used as well. In certain embodiments, the nanostructures include nanowires that have an average aspect ratio of at least about 4. These nanowires may have an average cross-section dimension of between about 1 nanometer and 2 micrometers or, more specifically between 600 nanometers and 1,500 nanometers in a fully discharged state. In the same or other embodiments, the nanowires have a length of at least about 10 micrometers in a fully discharged state.

In certain embodiments, depositing the amorphous silicon involves flowing a process gas containing silane into a Chemical Vapor Deposition (CVD) chamber. The concentration of silane in the process gas may be between about 1% and about 20%. While depositing the amorphous silicon, the nanostructures may be maintained at an average temperature of between about 200° C. and 700° C. Other examples of interconnecting materials include germanium, aluminum, nickel, copper, titanium, tungsten, molybdenum, and tantalum, each of which can be deposited by CVD or alternative methods. Some of these materials may be relatively ductile and/or may not lithiate. Interconnecting structures formed from such materials may provide strong mechanical support, especially at critical interconnecting locations. Generally, interconnecting materials may be deposited using various CVD, Physical Vapor Deposition (PVD), and atomic layer deposition (ALD) techniques at various stages during electrode fabrication. For example, an interconnecting material may be deposited in parallel with an active material. Alternatively, it may be deposited as a coating over an active material. Some other deposition techniques include slurry coating, solvent coating, or spraying that may be followed by annealing of the interconnecting materials, for example, to form silicides or other types of bonds.

In certain embodiments, the nanostructures are attached to a substrate. The substrate may be a copper foil, a stainless steel foil, a nickel foil, and/or a titanium foil. Other examples of the substrate may be used as well. In certain embodiments, at least about 10% of nanostructures are substrate rooted or, more specifically, at least about 20% or, even more specifically, at least about 30%, or even at least about 40% or at least about 50%. A portion of the amorphous silicon and/or germanium may be deposited on the substrate and provides additional mechanical support to the nanostructures and additional electrical connection between the nanostructures and the substrate. In certain embodiments, the nanostructures are attached to the substrate by a binder. The binder may be at least partially removed while depositing the amorphous silicon and/or germanium.

In certain embodiments, a method also involves compressing the nanostructures to electrically interconnect at least a portion of the nanostructures. Compressing may be performed while the nanostructures are maintained at a temperature of at least about 200° C. In the same or other embodiments, compressing may be performed while passing an electrical current through a layer formed by the nanostructures. Furthermore, compressing may be performed prior to or after depositing the amorphous silicon and/or germanium.

Provided also is a lithium ion electrode subassembly for use in a lithium ion cell. The lithium ion electrode subassembly may include nanostructures comprising an electrochemically active material and amorphous silicon and/or germanium deposited over the nanostructures and electrically interconnecting at least a portion of the nanostructures. Likewise, provided also is a lithium ion cell including nanostructures comprising an electrochemically active material and amorphous silicon and/or germanium deposited over the nanostructures and electrically interconnecting at least a portion of the nanostructures.

In certain embodiments, a method of fabricating a lithium ion electrode subassembly for use in a lithium ion cell involves receiving nanostructures comprising an electrochemically active material and forming an active layer, wherein at least 10% of the nanostructures are directly substrate rooted to a substrate and depositing an interconnecting material onto the active layer to electrically interconnect at least a portion of the nanostructures. In other embodiments, a fraction of nanostructures that are in direct contact with the substrate is significantly less. In these embodiments, the nanostructures form an interconnected electrode layer, and this layer as a whole is in direct contact with the substrate while most of the nanostructures in the layer have only indirect contact with the substrate. The interconnecting material may include a metal containing material. Some examples include copper, nickel, iron, chromium, aluminum, gold, silver, tin, indium, gallium, lead, and various combinations thereof. These materials may be provided as salts. The method may also involve treating the layer to electrically interconnect additional nanostructures and/or improve existing electrical connections. Some treating examples include heating the layer to at least 200° C., exerting pressure on the layer, and/or forming a metal silicide at interfaces of the nanostructures and the metal containing interconnecting material. Some examples of the electrochemically active material include silicon, germanium, and tin.

Provided also a method of fabricating a lithium ion electrode subassembly for use in a lithium ion cell that involves receiving nanostructures comprising an electrochemically active material, wherein the nanostructures form a layer and passing an electrical current through the layer to bond nanostructures and to electrically interconnect at least a portion of the nanostructures. The electrical current may be passed while the layer is compressed. In the same or other embodiments, the electrical current may be passed while the nanostructures are maintained at a temperature of at least about 200° C.

These and other features will be further described below with reference to the specific drawings.

### BRIEF DESCRIPTION OF THE DRAWINGS

FIG. 1 is a process flowchart representing a general method of fabricating a lithium ion electrode subassembly having at least partially interconnected nanostructures, in accordance with certain embodiments.

FIG. 2 illustrates two nanostructures with a layer of the silicon containing material deposited over the nanostructures that interconnects the two nanostructures, in accordance with certain embodiments.

FIG. 3 illustrates two nanostructures and an interconnecting material particle after depositing the interconnecting material, in accordance with certain embodiments.

FIG. 4 illustrates two nanostructures and a modified interconnecting material particle after performing one or more of post-deposition treatment operations, in accordance with certain embodiments.

FIGS. 5A-B are a top schematic view and a side schematic view of an illustrative electrode arrangement, in accordance with certain embodiments.

FIGS. 6A-B are a top schematic view and a perspective schematic view of an illustrative round wound cell, in accordance with certain embodiments.

FIG. 7 is a top schematic view of an illustrative prismatic wound cell, in accordance with certain embodiments.

FIGS. 8A-B are a top schematic view and a perspective schematic view of an illustrative stack of electrodes and separator sheets, in accordance with certain embodiments.

FIG. 9 is a schematic cross-section view of an example of a wound cell, in accordance with embodiments.

### DETAILED DESCRIPTION OF EXAMPLE EMBODIMENTS

In the following description, numerous specific details are set forth in order to provide a thorough understanding of the present invention. The present invention may be practiced without some or all of these specific details. In other instances, well known process operations have not been described in detail to not unnecessarily obscure the present invention. While the invention will be described in conjunction with the specific embodiments, it will be understood that it is not intended to limit the invention to the embodiments.

Nanostructures, and in particular nanowires, are potential new materials for battery applications. It has been proposed that high capacity electrode active materials can be deployed as nanostructures and used without sacrificing battery performance due to pulverization, loss of electrical and mechanical contacts among nanostructures, and other reasons. Even major swelling during lithiation, such as observed with silicon, does not deteriorate the structural integrity of certain nanostructures because of their small size. Specifically, at least one nano-scale dimension is available for expansion, and stresses during expansion and contraction may not reach the fracture level because of a small magnitude of expansion and contraction. Examples of nanostructures include nanoparticles, nanowires, nanofibers, nanorods, nano-flakes, and many other nano shapes and forms. Generally, at least one dimension of the nanostructures is less than about 1 micrometer, such a thickness of nano-flakes. Often two or more dimensions are less than about 1 micrometer, such as a cross-section of nanowires or all three dimensions of nanoparticles.

Nanowires have one principal dimension that is greater than two others. As such, nanowires have an aspect ratio of greater than one, typically at least about two and more frequently at least about four. Nanowires may make use of their principal dimension to connect to other electrode components, e.g., a substrate or other nanostructures. In certain embodiments, nanowires are substrate rooted such that one end or some other part is in contact with the substrate. Nanostructures with substrate-rooted ends are also referred to as terminally rooted nanostructures. In a specific embodiment, at least 50% nanostructures in the active layer are substrate rooted or terminally rooted. It should be noted that in order to achieve such a high ratio of the terminally rooted nanowires, the rooting should occur during initial formation (i.e., growth) of the nanostructures. In other embodiments, a fraction of the substrate rooted nanostructures is between about 10% and 50%. This fraction is believed to be sufficient to form an interconnected network of nanostructures (i.e., an electrode layer) with a sufficient active material loading to achieve commercially viable capacity levels. Higher substrate-rooted fractions may correspond to lower capacities (i.e., thinner electrode layers) or require longer nanowires to achieve the same capacity. In other words, a certain thickness of the interconnected network (i.e., the electrode layer) is needed to achieve certain capacity per unit area. Typical nanowire lengths of up to 20-25 micrometers may not be sufficient to provide commercially viable capacities and thicker interconnected networks are needed. These thicker networks result in many nanostructures not being directly connected to the substrate. Various trade-offs exist between nanowires' lengths, nanowires' orientations, a fraction of substrate rooted nanowires, and capacity that may or may not limit the electrode design. Because the two other dimensions of the nanowires are small and there is an adjacent void volume in the active layer available for expansion, the internal stress built up in the nanowires during lithiation is also small and does not break apart the nanowires as it happens with larger structures. In other words, two dimensions of the nanowires are kept below the corresponding fracture levels, which depend on an active material used, shape, and other parameters. In certain embodiments, an average cross-section dimension of the nanostructures is between about 1 nanometer and 2,000 nanometers on average in a fully discharged state or, more specifically between about 600 nanometers and 1,500 nanometers. Sizes of interconnecting structures may be between about 10 nanometers and 1,000 nanometers. At the same time, a principal dimension of the nanowires may be substantially larger, e.g., at least about 10 micrometers on average in a fully discharged state, without sacrificing the characteristics described above. As such, high-aspect ratio nanowires have the advantage of permitting a relatively high capacity (and material loading) per unit area of the electrode surface.

Nanostructures need to be in electrical connection with one of the cell electrical terminals in order to contribute to the cell's overall performance. A conductive substrate, such as a copper, nickel, stainless steel, or aluminum foil, may be used as an electrical conductor between the active material and the cell terminals and often as a mechanical support. In these embodiments, nanostructures can be arranged on one or both side the substrate. Nanostructures can form electrical connection with the substrate by a direct contact (e.g., substrate rooted nanowires) with the substrate or by an indirect contact (e.g., through other nanostructures containing active materials, conductive additives).

For the purposes of this document, “interconnected nanostructures” are formed by a technique that forms new electrical connections or enhances existing ones among at least a portion of the nanostructures. Interconnected nanostructures may be arranged into an active layer. This technique may also involve forming new electrical connections between some nanostructures and a substrate, if one is present, and enhancing existing connections. Interconnecting may also involve establishing new and/or enhancing existing mechanical bonds among nanostructures and/or between nanostructures and the substrate. Interconnecting may be direct (e.g., two nanostructures are in direct electrical contact with each other) or indirect (e.g., two nanostructures are connected through one or more interconnecting material structures). In certain embodiments, physical and conductive bonds are formed among nanostructures and/or between the nanostructures and substrate. These and other examples will now be described in more detail.

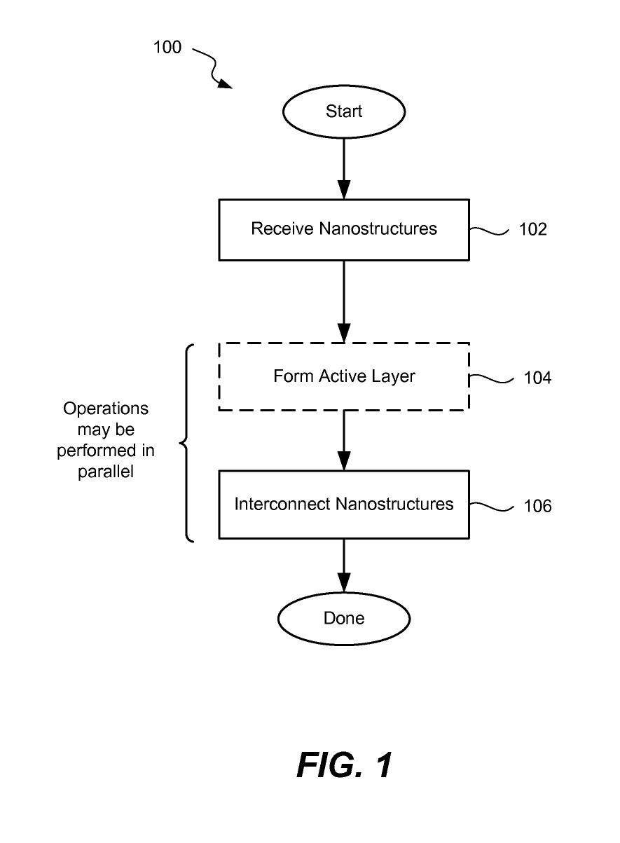

FIG. 1 is a process flowchart corresponding to a general method for fabricating a lithium ion electrode subassembly with at least partially interconnected nanostructures for use in a lithium ion cell, in accordance with certain embodiments. The process 100 may start with receiving nanostructures containing an electrochemically active material in operation 102. In certain embodiments, nanostructures include silicon containing materials, such as crystalline and/or amorphous silicon, germanium containing materials, and/or tin containing materials. Other active material examples are described below. Nanostructures may include other materials that are not necessarily electrochemically active. For example, nanostructures may include materials that can enhance interconnecting.

In certain specific embodiments, base nanostructures contain substantially no active material or contribution of this active material to the overall electrode capacity may be minimal. For example, base nanostructure may include nickel silicides. These structures are later interconnected with one or more active materials that provide substantially all capacity to the electrode. For example, amorphous silicon may be deposited over the nickel silicide structures. Generally, nickel silicide base structures will not significantly contribute to the overall cell capacity. Cycling regimes may be designed such that very little or no lithiation occurs in these base structures. This limited lithiation feature may be used, for example, to preserve base structures in their original form and to maintain adhesion of these structures to the substrate. In other examples, capacity contribution of base nanostructures may be at least about 10% or, more specifically, at least about 25%, or even at least about 50% or even at least about 75%. One such example involves silicon nanowires that may be formed using a vapor-liquid-solid (VLS) growth technique that are later coated with and interconnected by an amorphous silicon layer deposited over the silicon nanowires using, for example, a CVD technique.

If multiple materials are present in nanostructures, these materials may be distributed in a variety of ways. For example, one or more materials may be distributed evenly throughout the nanostructure volume, e.g., across their cross-sectional dimensions, such as a diameter of the nanowire. Distribution may also follow certain profiles (e.g., gradual distribution). For example, a material that enhances interconnection, helps formation of desirable SEI layer composition, and/or provide other surface characteristics may be positioned near the surface of the nanostructures. Further, multiple materials may form core-shell like structures, which are further described in U.S. Provisional patent application Ser. No. 12/787,168 by Cui et al. entitled “CORE-SHELL HIGH CAPACITY NANOWIRES FOR BATTERY ELECTRODES” filed on May 25, 2010, which is incorporated herein by reference in its entirety for purposes of describing core-shell structures.

Nanostructures received in operation 102 may already be in the form of an active layer. In these embodiments, the process does not include operation 104. Nanostructures may be held together in an active layer by a substrate, binders, and other means. Examples of substrates include a copper foil, stainless steel foil, nickel foil, and titanium foil. Other substrate examples are listed below. In certain embodiments, nanostructures are substrate rooted, which is further described in U.S. patent application Ser. No. 12/437,529 entitled “ELECTRODE INCLUDING NANOSTRUCTURES FOR RECHARGEABLE CELLS” filed on May 7, 2009 incorporated herein by reference in its entirety for purposes of describing substrate rooted structures. Substrate rooted nanostructures form direct bonds with the substrate without a binder. In other non-substrate rooted embodiments, nanostructures may be held together and/or attached to the substrate by a binder, such as polyvinylidene fluoride (PVDF), carboxymethyl cellulose (CMC), and polyacrylic acid (PAA). A binder may later be partially or completely removed from the active layer.

In other embodiments, received nanostructures are not arranged into an active layer and the process 100 may proceed with formation of an active layer in operation 104. For example, nanostructures may initially be in a loose form, e.g., a powder. Such nanostructures may be produced by electrospinning, chemical etching, thermal or chemical reduction/conversion, free-standing CVD (e.g., in a fluidized bed reactor), PVD, solution based synthesis, or any other suitable fabrication technique. Some nanostructures are commercially available from various suppliers. For example, silicon nanorods are available from American Elements in Los Angeles, Calif. (e.g., product code SI-M-01-NR). Forming an active layer in operation 104 may involve mixing nanostructures into slurry, which may contain a polymeric binder, e.g., PVDF. A binder and/or other material can help to retain the nanostructures in the active layer permanently or temporary (e.g., until the interconnection operation itself establishes permanent bonds). It should be noted that bonds established during interconnection operations described below are distinguishable from support that a typical binder provides to active material structures in the active layer. The bonds established during or after such interconnection operations can be characterized, in certain embodiments, as chemical and/or metallurgical bonds. These bonds are generally electrically conductive in addition to providing mechanical support to interconnected nanostructures. In certain embodiments, a binder is later at least partially removed from the active layer to allow for additional swelling of the nanostructures and to provide ion transfer pathways. Complete or partial removal of the binder may also improve electrical contact and adhesion among other structures, such as between coated silicon structures and active silicon particles. The bond between the nanostructures is used for support and electrical interconnection. A slurry may be then deposited onto the substrate and dried. Alternatively, nanostructures may be arranged on a substrate or any other supporting surface and temporarily held on that surface by gravitational forces, Van der Waals forces, an electrostatic field, an electromagnetic field, surface tension (e.g., slurry), or other means. It should be noted that an active layer formed in 104 or other operations may be modified during subsequent processing. For example, an initially formed active layer may become thinner after compressing the layer as described below.

The overall process 100 continues with interconnecting nanostructures in operation 106. Interconnecting may involve adding one or more interconnecting materials, which may be introduced into the active layer prior to or during the interconnection operation. In certain embodiments, deposition of an interconnecting material is sufficient for establishing the necessary interconnection and no additional processing is required to complete operation 106. In other embodiments, deposition is followed by performing one or more bonding techniques. In other embodiments, interconnection may be performed without any interconnecting materials, i.e., forming direct bonds among nanostructures and/or between nanostructures and the substrate. In some embodiments, formation of the active layer and interconnection of the nanostructures may be performed in parallel. For example, a collection of the nanostructures may be formed into an active layer by compressing these structures, which also forms some bonds between the nanostructures. These examples will now be described in more detail.

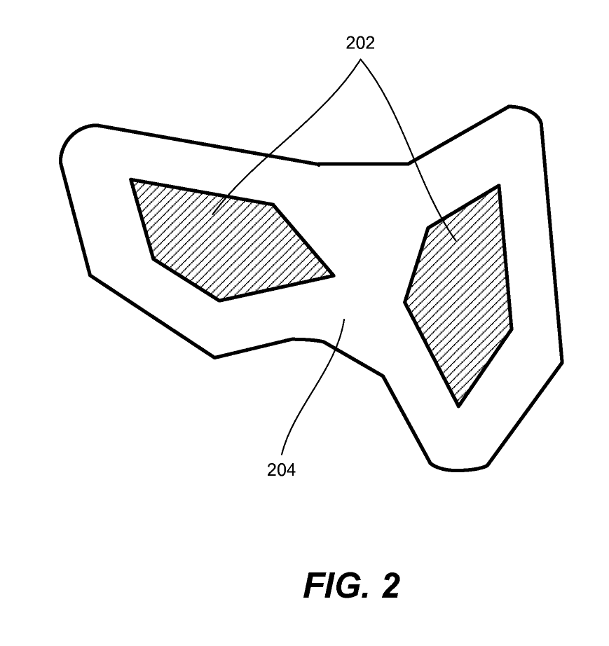

As mentioned above, the interconnecting operation may involve depositing one or more interconnecting materials, such as a silicon containing material (e.g., amorphous silicon), carbon containing materials (e.g., from a decomposed binder), germanium (which allows lower deposition temperature that may reduce or eliminate formation of various undesirable species, e.g., silicides), or a metal containing material (e.g., copper particles). Deposition techniques may involve mechanical distribution of particles, electrochemical plating, chemical vapor deposition (CVD), sputtering, physical vapor deposition (PVD), chemical condensation, and other deposition techniques. In certain embodiments, depositing interconnecting materials establishes sufficient electrical connections and no other post-deposition processing is needed for interconnecting nanostructures. FIG. 2 illustrates an example of a layer 204 that may form on the nanostructures 202 during deposition of the interconnecting material. As it can be seen from the figure, the layer 204 interconnects two particles. One specific example is depositing silicon containing materials using CVD further described below.

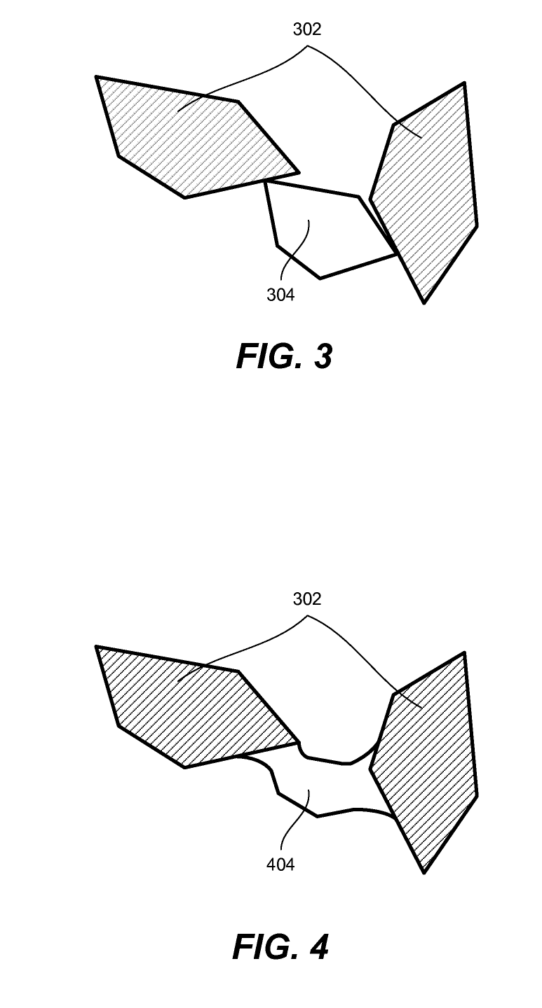

In other embodiments, additional processing steps are performed after depositing an interconnecting material. These post deposition steps are needed to form new connections and/or enhance existing connections and are considered to be a part of operation 108 even though multiple separate processing steps may be involved in this operation. An interconnecting material may be introduced into the active layer before or after the active layer is formed. For example, loose nanostructures may be mixed with interconnecting material particles. Interconnecting material particles may take various shapes, e.g., wires, rods, filaments, meshes, foams, and others. This mixture may be then formed into an active layer, for example, in operation 104. If an interconnecting material is introduced after the layer is formed, an active layer may have a sufficient porosity (i.e., a ratio of the void volume to the total volume) that allows the material to penetrate into the layer. FIG. 3 illustrates an arrangement including two nanostructures 302 and an interconnecting material particle 304, which may be present after depositing the interconnecting material in accordance with certain embodiments. While some contact may exist between the nanostructures 302 after the deposition as, for example, illustrated in FIG. 3, this contact may be inadequate from the battery performance perspective. Further, many nanostructures may remain electrically disconnected from other nanostructures and/or the substrate.

As such, an active layer containing nanostructures and one or more interconnecting materials may need to be further processed in operation 106 to establish a sufficient degree of interconnection (e.g., a certain conductivity and/or mechanical strength) in the active layer. Various techniques, such as heating, compressing, or passing electrical current, can be used. Selection among these techniques depends, in part, on nanostructure materials and interconnecting materials as well as other factors. For example, if metallic particles are used for interconnection, then the layer may be heated in order to melt these particles and to allow the molten metal to flow around the nanostructures and/or fuse or alloy with adjacent nanostructures.

In certain embodiments, metals form an interconnecting alloy with the nanostructures or in some cases, silicides with silicon containing nanostructures. It should be noted that forming an alloy as opposed to establishing a mechanical surface contact (created by, e.g., compression alone) generally results in much stronger mechanical bonds and provides better electrical conductivity. Such alloy interconnection may be beneficial, in particular when used with high-capacity nanostructures, e.g., silicon nanowires.

As explained above, many such nanostructures have poor electrical conductivity themselves and may loose their electrical connections with the substrate during cycling. Highly conductive and mechanically strong interconnects can help to mitigate these issues and help to maintain more active materials in electrical communication with the substrate over more cycles and/or deeper cycles. FIG. 4 illustrates an example of two nanostructures 402 and a modified interconnecting material particle 404 after performing one or more of these bonding techniques. It should be noted that bonding techniques may be used to establish greater contact surface areas and form various interphase materials (e.g., chemical reaction products, alloys, and other morphological combinations). Some of these examples are further described below.

In certain embodiments, interconnection may be performed in operation 106 without adding any special interconnecting materials to the active layer. In other words, nanostructures form direct connections with each other and/or substrate during processing of the active layer. Nanostructures may be directly interconnected by applying pressure, heat, and/or electrical current or using other bonding techniques described below. In particular embodiments, a surface of the nanostructures can be modified or functionalized to enhance such interconnections.

Various examples of interconnecting techniques described herein can be combined together into the same operation or a series of sequential operations. For example, interconnecting nanostructures by compressing or passing an electrical current may be followed by depositing a silicon containing material to further improve electrical connections.

In particular embodiments, nanostructures are interconnected by depositing a silicon containing material, such as amorphous silicon. An active layer with nanostructures is provided into a CVD chamber. The following description and process parameters relate generally to PECVD processing. However, the silicon containing interconnecting material can be deposited by other processed as well, notably thermal CVD. A thermal CVD process generally employs relatively high deposition temperatures, e.g., between about 300° C. and 600° C. for silane or, more specifically, between about 450° C. and 550° C. If di-silane is used, then deposition temperature may be less than about 400° C. Germanium may be deposited using a thermal CVD technique at a temperature of between about 200° C. and 400° C. Temperatures used for PECVD deposition may be lower.

Nanostructures may be first heated. A process gas containing a silicon containing precursor, such as silane, and one or more carrier gases, such as argon, nitrogen, helium, hydrogen, oxygen, carbon dioxide, and methane, is introduced into the chamber. In a specific example, a concentration of silane in helium is between about 5% and 20% based on the partial pressures or, more specifically, between about 8% and 15%. The process gas may also include a dopant containing material, such as phosphine. In certain embodiments, a chamber is maintained at a pressure of between about 0.1 Torr to 10 Torr or, more specifically, at between about 0.5 Torr and 2 Torr. To enhance decomposition of the silicon containing precursor a plasma may be ignited in the chamber.

The following process (i.e., RF power and flow rates) parameters are provided for STS MESC Multiplex CVD system available from Surface Technology Systems in United Kingdom that can process substrates up to about 4 inches in diameter. It should be understood by one having ordinary skills in the art that these process parameters can be scaled up or down for other types chambers and substrate sizes. In certain embodiments, an RF power may be maintained at between about 10 W and 100 W and the overall process gas flow rate may be kept at between about 200 sccm and 1000 sccm or, more specifically, at between about 400 sccm and 700 sccm.

In a specific embodiment, forming an interconnecting layer of amorphous silicon is performed in a process chamber maintained at a pressure of about 1 Torr. The process gas contains about 50 sccm of silane and about 500 sccm of helium. In order to dope the active material, about 50 sccm of 15% phosphine may be added to the process gas. The substrate is kept at about 300° C. The RF power level is set to about 50 Watts.

To achieve an adequate thickness of the silicon containing material, which is needed to provide adequate interconnection of nanostructures, deposition may be performed for between about 5 minutes and 30 minutes. A deposited thickness of the active material may be driven by energy density requirements, material properties (e.g., theoretical capacity, stress fracture limits), template surface area, and other parameters. In certain embodiments, a layer of amorphous silicon that is between about 10 nanometers and 500 nanometers thick, or more specifically, between about 50 nanometers and 300 nanometers thick is deposited. It has been determined that such layers can be typically deposited within 10-20 minutes. It should be noted that a desired thickness depends on porosity of the active layer, shape and orientation of the nanostructures, a degree of cross-linking desired for this layer.

Nanostructures may be also interconnected using one or more metal containing interconnecting materials, such as metal particles, metal nanowires, or metal solder. Examples of metal containing materials include copper, nickel, iron, chromium, aluminum, gold, silver, tin, indium, gallium, lead, or various combinations thereof. In particular embodiments, metal containing materials include lithium. Some of this lithium may later serve as charge carrying ions and may be used, for example, to compensate for lithium losses during formation cycling. It should be noted that metals used for interconnecting should be electrochemically stable. Particle size may depend on whether the particles are introduced prior to formation of the active layer, which may allow using larger particles, or after the active layer is form, which may require smaller particles capable of penetrating into the active layer.

A metal solder may include tin, lead, copper, zinc, silver, other materials, and combinations thereof (e.g., tin-lead, copper-zinc, copper-silver). A solder may be applied to the substrate prior to formation of an active layer on the substrate. In the same or other embodiments, a solder may introduced onto nanostructures prior or during formation of the active layer. A solder may also be introduced after formation of the active layer. A surface of the nanostructures may be specially treated to enhance a flow of the solder over the surface and to the nanostructures' juncture points.

Interconnecting nanostructures with a metal containing interconnecting material may require performing one or more bonding techniques, such heating, compressing, and passing electrical current. In specific embodiments, a mixture of nanostructures and a metal containing interconnecting material is heated to at least 200° C. A pressure may be also applied on the mixture during heating. Nanostructures that contain silicon may form metal silicides at the interface of the nanostructures and the interconnecting material. Complementary processing operations may include surface functionalization, pH modification, and/or etching to promote good adhesion and/or activation. Functionalization examples include changing hydrophobicity by modifying the surface of the base structures by hydrosilylation with functional groups or hydrogen termination using hexamethyldisilazane (HMDS) or other chemicals. Additionally, surfactants may be used to achieve the desired dispersion uniformity.

It has been found that nanostructures can be also interconnected by applying a pressure on the active layer. Interconnection may result when two structures “fuse” together without a need of any additional interconnecting materials. Further, this technique can also be used with various interconnecting materials described in this document. A pressure level, duration, and other process parameters (e.g., heating) may depend on nanostructure and substrate materials, spatial arrangement and spatial characteristics of the nanostructures (e.g., dimensions, porosity), mechanical characteristics (elasticity, hardness), and other factors. Heating may generally expedite this binding technique. Further, heated nanostructures may be more flexible and required less pressure to fuse, which may help to avoid damaging nanostructures. In particular embodiments, nanostructures are heated to at least about 200° C. or, more specifically, to at least about 300° C. or even at least about 700° C. In certain specific embodiments, heating was performed in an inert atmosphere at about 50 Torr with argon flown at about 500 sccm. In other embodiments, a reducing environment was used and included, for example, about 4% of hydrogen in argon. This mixture was supplied to a chamber kept at about 50 Torr at a flow rate of about 500 sccm. In alternative embodiments, heating is performed in an oxidizing environment. For example, air may be used at an ambient pressure of about 760 Torr.

Another method of interconnecting nanostructures is by passing an electrical current through an active layer containing the nanostructures. Similar to the pressure technique described above, this technique can be practiced with or without interconnecting materials. Further, this technique can be combined with other interconnecting techniques described in this document. For example, a current may be passed through an active layer while it is under a pressure. The layer may also be heated to further promote interconnecting.

Without being restricted to any particular theory, it is believed that when an electrical current is passed through the active layer, highly resistive nanostructures' contact points heat up. This heating may cause various morphological distortions, including melting, that help to form bonds among the nanostructures at these points.

In order to pass an electrical current through an active layer, the layer may be compressed between two metal plates. These plates may have specially treated surfaces to prevent welding of the nanostructures and substrates to the plates. DC or AC voltage is then applied to these plates. A voltage level may depend on the initial conductivity of the active layer and other factors (e.g., material characteristics). In order to lower this resistance, nanostructures may be doped and/or conductive additives may be added to the active layer.

Interconnecting nanostructures may also involve forming electrical connections and, in certain embodiments, mechanical bonds with a substrate. In one example, nanostructures received in a loose form are first dispersed onto a substrate surface. At least a part of these nanostructures is then fused with the substrate by, for example, thermal annealing. It was found that at a high temperature, e.g., at least about 200° C. or, more specifically, at least about 300° C., certain nanostructure material may chemically react with certain substrate materials or form alloys or some other combinations. For example, heating silicon containing nanostructures in contact with a copper surface to at least about 200° C. may result in formation of various copper silicide phases. These silicides can provide both mechanical support and/or electrical connection to the nanostructures. Further, silicides tend to swell less than silicon during cycling, which helps to retain these substrate-to-nanostructure bonds.

Nanostructures can be connected to a substrate by various other techniques described in this document. For example, a silicon containing material may be deposited over the nanostructures dispersed on the substrate as described above. During deposition, the silicon containing precursor may penetrate through the active layer and reach the substrate. As such, the silicon containing material is deposited at the interface of the nanostructures and substrate. This interface deposition may similarly provide mechanical support and electrical connection between nanostructures and to the substrate.

In certain embodiments, a substrate includes one or more surface layers that enhance the interconnection with nanostructures. For example, a thin layer (e.g., between about 100 nm and 10 μm) of a solder, such as tin, copper, gold, their alloys, and various other types of solder, may be deposited on the substrate surface. Nanostructures are then dispersed over this “functionalized” surface. Such composite may be then heated and, in certain embodiments, compressed. Further, a composite may be oriented in such a way that the substrate and the solder layer appear above the active layer. The solder, once melted, may at least partially penetrate into the active layer under gravitational and surface tension forces and may help to interconnect nanowires as well as connect at least a portion of the nanowires to the substrate.

Nanostructures that can be interconnected using one or more techniques described herein include at least one electrochemical active material. This material is suitable for insertion and removal of lithium ions during battery cycling. Examples of electrochemically active materials include silicon containing materials (e.g., crystalline silicon, amorphous silicon, other silicides, silicon oxides, sub-oxides, oxy-nitrides), tin-containing materials (e.g., tin, tin oxide), germanium, carbon-containing materials, a variety of metal hydrides (e.g., MgH₂), silicides, phosphides, and nitrides. Other examples include carbon-silicon combinations (e.g., carbon-coated silicon, silicon-coated carbon, carbon doped with silicon, silicon doped with carbon, and alloys including carbon and silicon), carbon-germanium combinations (e.g., carbon-coated germanium, germanium-coated carbon, carbon doped with germanium, and germanium doped with carbon), and carbon-tin combinations (e.g., carbon-coated tin, tin-coated carbon, carbon doped with tin, and tin doped with carbon). While the above listed materials are generally used to fabricate negative electrode subassemblies, the described techniques can also be used for fabrication positive electrode subassemblies. Examples of positive electrochemically active materials include various lithium metal oxides (e.g., LiCoO₂, LiFePO₄, LiMnO₂, LiNiO₂, LiMn₂O₄, LiCoPO₄, LiNi_{1/3}CO_{1/3}Mn_{1/3}O₂, LiNi_{X}CO_{Y}Al_{Z}O2, LiFe₂(SO4)₃, Li₂FeSiO₄, Na₂FeO₄), carbon fluoride, metal fluorides such as iron fluoride (FeF₃), metal oxide, sulfur, and combination thereof.

Doped and non-stoichiometric variations of these positive and negative active materials may be present in nanostructures interconnected using various techniques described herein. Some examples of dopants includes elements from the groups III and V of the periodic table, such as boron, aluminum, gallium, indium, thallium, phosphorous, arsenic, antimony, and bismuth, as well as other suitable dopants, such as sulfur, selenium, and lithium. Dopants can be used to improve conductivity of the nanostructures, which may be important from electrochemical and/or processing perspectives further addressed above.

A substrate may become a part of the electrode (e.g., a current collector), or used as a temporary carrier that supports an electrode layer containing active material and other structures during fabrication, and/or a source of materials during electrode fabrication (e.g., a source of metal in a metal silicide deposition operation). If a substrate becomes a part of the electrode, it may generally include a material suitable for use in this electrode (from mechanical, electrical, and electrochemical perspectives). Examples include copper, copper coated metal oxides, stainless steel, titanium, aluminum, nickel, chromium, tungsten, metal nitrides, metal carbides, carbon, carbon fiber, graphite, graphene, carbon mesh, conductive polymers, or combinations of above including multi-layer structures. Substrate may be formed as a foil, film, mesh, foam, laminate, wires, tubes, particles, multi-layer structure, or any other suitable configuration. In certain embodiments, a base material is a metallic foil with a thickness of between about 1 micrometer and 50 micrometers or, more specifically between about 5 micrometers and 30 micrometers. Substrate may be provided on a roll, sheet, or any other form that is fed into a process apparatus that is used in one or more of subsequent operations.

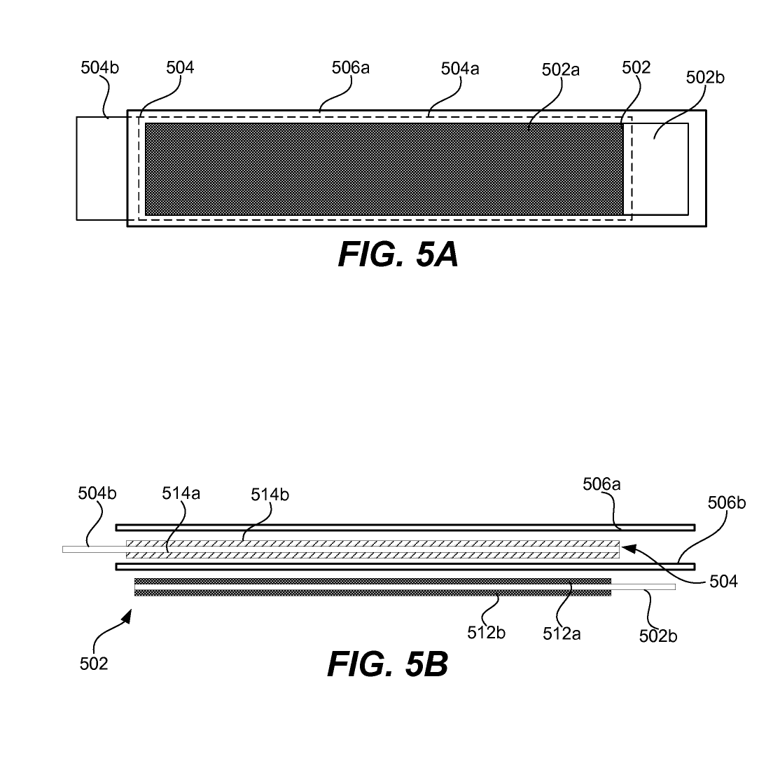

Electrodes are typically assembled into a stack or a jelly roll. FIGS. 5A and 5B illustrates a side and top views of an aligned stack including a positive electrode 502, a negative electrode 504, and two sheets of the separator 506a and 506b, in accordance with certain embodiments. The positive electrode 502 may have a positive active layer 502a and a positive uncoated substrate portion 502b. Similarly, the negative electrode 504 may have a negative active layer 504a and a negative uncoated substrate portion 504b. In many embodiments, the exposed area of the negative active layer 504a is slightly larger that the exposed area of the positive active layer 502a to ensure that most or all lithium ions released from the positive active layer 502a go into the negative active layer 504a. In one embodiment, the negative active layer 504a extends at least between about 0.25 and 5 mm beyond the positive active layer 502a in one or more directions (typically all directions). In a more specific embodiment, the negative layer extends beyond the positive layer by between about 1 and 2 mm in one or more directions. In certain embodiments, the edges of the separator sheets 506a and 506b extend beyond the outer edges of at least the negative active layer 504a to provide electronic insulation of the electrode from the other battery components. The positive uncoated substrate portion 502b may be used for connecting to the positive terminal and may extend beyond negative electrode 504 and/or the separator sheets 506a and 506b. Likewise, the negative uncoated portion 504b may be used for connecting to the negative terminal and may extend beyond positive electrode 502 and/or the separator sheets 506a and 506b.

The positive electrode 502 is shown with two positive active layers 512a and 512b on opposite sides of the flat positive current collector 502b. Similarly, the negative electrode 504 is shown with two negative active layers 514a and 514b on opposite sides of the flat negative current collector. Any gaps between the positive active layer 512a, its corresponding separator sheet 506a, and the corresponding negative active layer 514a are usually minimal to non-existent, especially after the first cycle of the cell. The electrodes and the separators are either tightly wound together in a jelly roll or are positioned in a stack that is then inserted into a tight case. The electrodes and the separator tend to swell inside the case after the electrolyte is introduced, and the first cycles remove any gaps or dry areas as lithium ions cycle the two electrodes and through the separator.

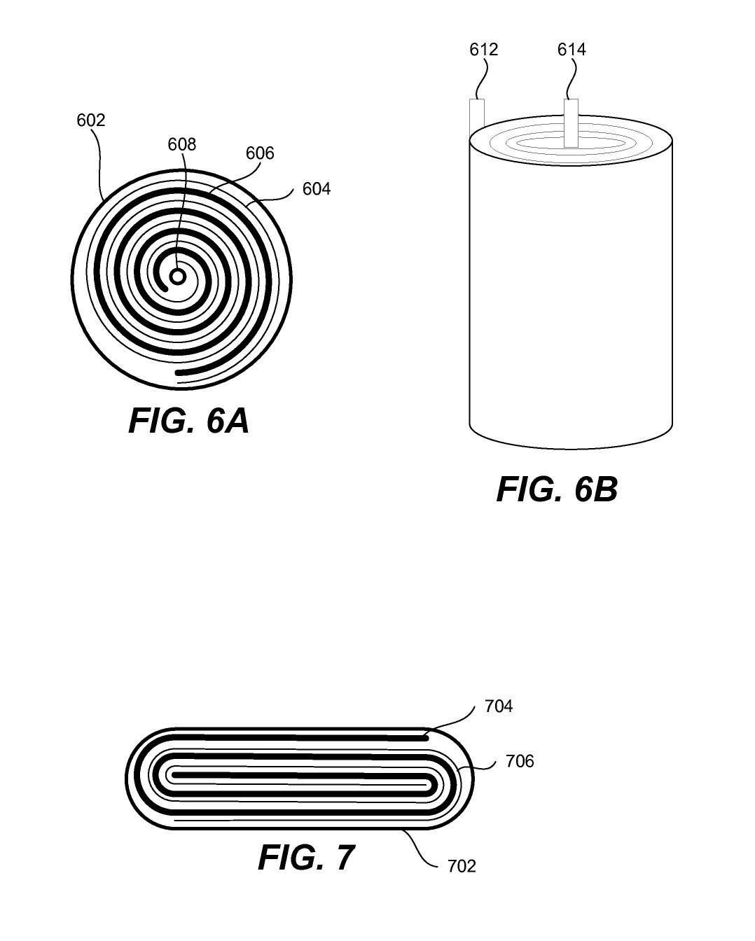

A wound design is a common arrangement. Long and narrow electrodes are wound together with two sheets of separator into a sub-assembly (sometimes referred to as a jellyroll), which is shaped and sized according to the internal dimensions of a curved, often cylindrical, case. FIG. 6A shows a top view of a jelly roll comprising a positive electrode 606 and a negative electrode 604. The white spaces between the electrodes represent the separator sheets. The jelly roll is inserted into a case 602. In some embodiments, the jellyroll may have a mandrel 608 inserted in the center that establishes an initial winding diameter and prevents the inner winds from occupying the center axial region. The mandrel 608 may be made of conductive material, and, in some embodiments, it may be a part of a cell terminal. FIG. 6B presents a perspective view of the jelly roll with a positive tab 612 and a negative tab 614 extending from the jelly roll. The tabs may be welded to the uncoated portions of the electrode substrates.

The length and width of the electrodes depend on the overall dimensions of the cell and the heights of the active layers and current collector. For example, a conventional 18650 cell with 18 mm diameter and 65 mm length may have electrodes that are between about 300 and 1000 mm long. Shorter electrodes corresponding to low rate/higher capacity applications are thicker and have fewer winds.

A cylindrical design may be desirable for some lithium ion cells because the electrodes swell during cycling and exert pressure on the casing. A round casing may be made sufficiently thin and still maintain sufficient pressure. Prismatic cells may be similarly wound, but their case may bend along the longer sides from the internal pressure. Moreover, the pressure may not be even within different parts of the cells, and the corners of the prismatic cell may be left empty. Empty pockets may not be desirable within the lithium ions cells because electrodes tend to be unevenly pushed into these pockets during electrode swelling. Moreover, the electrolyte may aggregate and leave dry areas between the electrodes in the pockets, which negatively affects the lithium ion transport between the electrodes. Nevertheless, for certain applications, such as those dictated by rectangular form factors, prismatic cells are appropriate. In some embodiments, prismatic cells employ stacks of rectangular electrodes and separator sheets to avoid some of the difficulties encountered with wound prismatic cells.

FIG. 7 illustrates a top view of a wound prismatic jellyroll positions in a case 702. The jelly roll comprises a positive electrode 704 and a negative electrode 706. The white space between the electrodes is representative of the separator sheets. The jelly roll is inserted into a rectangular prismatic case. Unlike the cylindrical jellyrolls shown in FIGS. 6A and 6B, the winding of the prismatic jellyroll starts with a flat extended section in the middle of the jelly roll. In one embodiment, the jelly roll may include a mandrel (not shown) in the middle of the jellyroll onto which the electrodes and separator are wound.

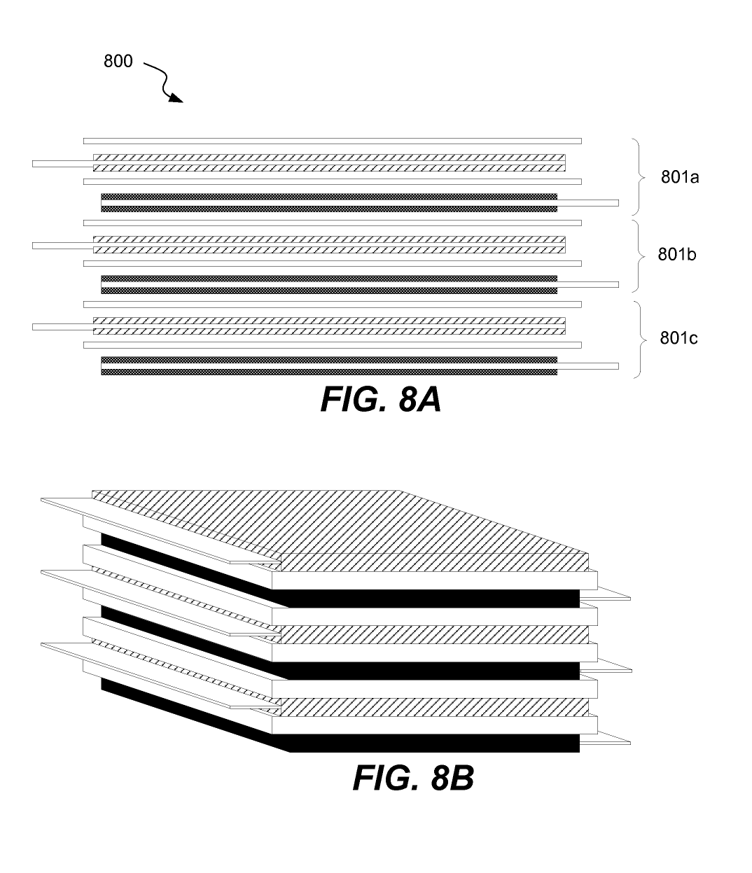

FIG. 8A illustrates a side view of a stacked cell 800 that includes a plurality of sets (801a, 801b, and 801c) of alternating positive and negative electrodes and a separator in between the electrodes. A stacked cell can be made to almost any shape, which is particularly suitable for prismatic cells. However, such a cell typically requires multiple sets of positive and negative electrodes and a more complicated alignment of the electrodes. The current collector tabs typically extend from each electrode and connect to an overall current collector leading to the cell terminal.

Once the electrodes are arranged as described above, the cell is filled with electrolyte. The electrolyte in lithium ions cells may be liquid, solid, or gel. The lithium ion cells with the solid electrolyte are referred to as a lithium polymer cells.

A typical liquid electrolyte comprises one or more solvents and one or more salts, at least one of which includes lithium. During the first charge cycle (sometimes referred to as a formation cycle), the organic solvent in the electrolyte can partially decompose on the negative electrode surface to form a SEI layer. The interphase is generally electrically insulating but ionically conductive, thereby allowing lithium ions to pass through. The interphase also prevents decomposition of the electrolyte in the later charging sub-cycles.

Some examples of non-aqueous solvents suitable for some lithium ion cells include the following: cyclic carbonates (e.g., ethylene carbonate (EC), propylene carbonate (PC), butylene carbonate (BC) and vinylethylene carbonate (VEC)), vinylene carbonate (VC), lactones (e.g., gamma-butyrolactone (GBL), gamma-valerolactone (GVL) and alpha-angelica lactone (AGL)), linear carbonates (e.g., dimethyl carbonate (DMC), methyl ethyl carbonate (MEC), diethyl carbonate (DEC), methyl propyl carbonate (MPC), dipropyl carbonate (DPC), methyl butyl carbonate (NBC) and dibutyl carbonate (DBC)), ethers (e.g., tetrahydrofuran (THF), 2-methyltetrahydrofuran, 1,4-dioxane, 1,2-dimethoxyethane (DME), 1,2-diethoxyethane and 1,2-dibutoxyethane), nitrites (e.g., acetonitrile and adiponitrile) linear esters (e.g., methyl propionate, methyl pivalate, butyl pivalate and octyl pivalate), amides (e.g., dimethyl formamide), organic phosphates (e.g., trimethyl phosphate and trioctyl phosphate), organic compounds containing an S═O group (e.g., dimethyl sulfone and divinyl sulfone), and combinations thereof.

Non-aqueous liquid solvents can be employed in combination. Examples of these combinations include combinations of cyclic carbonate-linear carbonate, cyclic carbonate-lactone, cyclic carbonate-lactone-linear carbonate, cyclic carbonate-linear carbonate-lactone, cyclic carbonate-linear carbonate-ether, and cyclic carbonate-linear carbonate-linear ester. In one embodiment, a cyclic carbonate may be combined with a linear ester. Moreover, a cyclic carbonate may be combined with a lactone and a linear ester. Other components may include fluoroethylene carbonate (FEC) and pyrocarbonates. In a specific embodiment, the ratio of a cyclic carbonate to a linear ester is between about 1:9 to 10:0, preferably 2:8 to 7:3, by volume.

A salt for liquid electrolytes may include one or more of the following: LiPF₆, LiBF₄, LiClO₄LiAsF₆, LiN(CF₃SO₂)₂, LiN(C₂F₅SO₂)₂, LiCF₃SO₃, LiC(CF₃SO₂)₃, LiPF₄(CF₃)₂, LiPF₃(C₂F₅)₃, LiPF₃(CF₃)₃, LiPF₃(iso-C₃F₇)₃, LiPF₅(iso-C₃F₇), lithium salts having cyclic alkyl groups (e.g., (CF₂)₂(SO₂)₂ₓLi and (CF₂)₃(SO₂)₂ₓLi), lithium-fluoroalkyl-phosphates (LiFAP), lithium bis(oxalato)borate (LiBOB), and combinations thereof. Common combinations include LiPF₆ and LiBF₄, LiPF₆ and LiN(CF₃SO₂)₂, LiBF₄ and LiN(CF₃SO₂)₂.

In one embodiment, the total concentration of salt in a liquid non-aqueous solvent (or combination of solvents) is at least about 0.3 M; in a more specific embodiment, the salt concentration is at least about 0.7M. The upper concentration limit may be driven by a solubility limit or may be no greater than about 2.5 M; in a more specific embodiment, it may be no more than about 1.5 M.

A solid electrolyte is typically used without the separator because it serves as the separator itself. It is electrically insulating, ionically conductive, and electrochemically stable. In the solid electrolyte configuration, a lithium containing salt, which could be the same as for the liquid electrolyte cells described above, is employed but rather than being dissolved in an organic solvent, it is held in a solid polymer composite. Examples of solid polymer electrolytes may be ionically conductive polymers prepared from monomers containing atoms having lone pairs of electrons available for the lithium ions of electrolyte salts to attach to and move between during conduction, such as polyvinylidene fluoride (PVDF) or chloride or copolymer of their derivatives, poly(chlorotrifluoroethylene), poly(ethylene-chlorotrifluoro-ethylene), or poly(fluorinated ethylene-propylene), polyethylene oxide (PEO) and oxymethylene linked PEO, PEO-PPO-PEO crosslinked with trifunctional urethane, poly(bis(methoxy-ethoxy-ethoxide))-phosphazene (MEEP), triol-type PEO crosslinked with difunctional urethane, poly((oligo)oxyethylene)methacrylate-co-alkali metal methacrylate, polyacrylonitrile (PAN), polymethylmethacrylate (PNMA), polymethylacrylonitrile (PMAN), polysiloxanes and their copolymers and derivatives, acrylate-based polymer, other similar solvent-free polymers, combinations of the foregoing polymers either condensed or cross-linked to form a different polymer, and physical mixtures of any of the foregoing polymers. Other less conductive polymers that may be used in combination with the above polymers to improve the strength of thin laminates include: polyester (PET), polypropylene (PP), polyethylene napthalate (PEN), polyvinylidene fluoride (PVDF), polycarbonate (PC), polyphenylene sulfide (PPS), and polytetrafluoroethylene (PTFE).

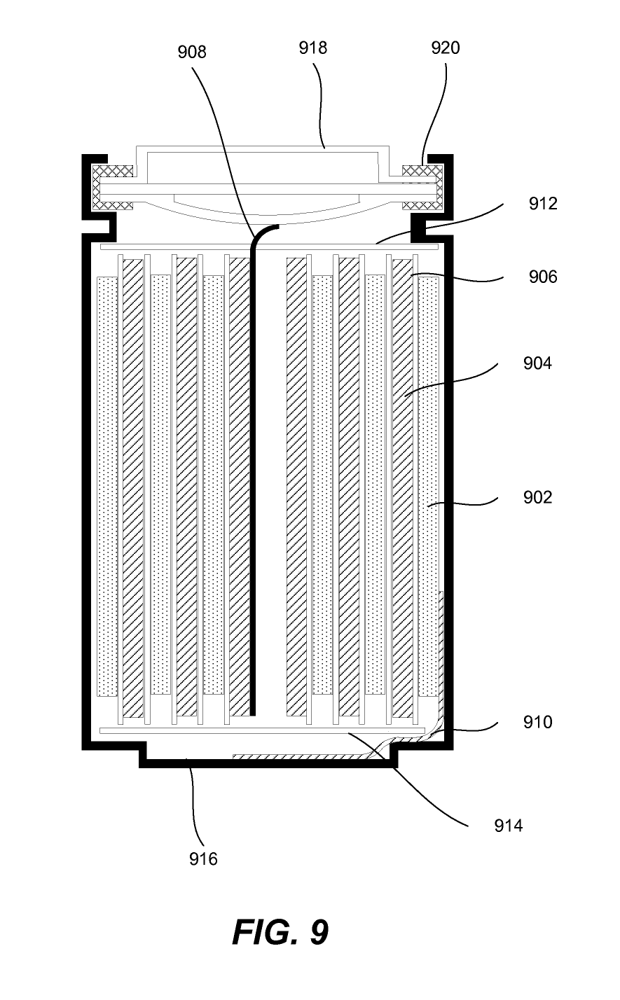

FIG. 9 illustrates a cross-section view of a wound cylindrical cell, in accordance with one embodiment. A jelly roll comprises a spirally wound positive electrode 902, a negative electrode 904, and two sheets of the separator 906. The jelly roll is inserted into a cell case 916, and a cap 918 and gasket 920 are used to seal the cell. It should be noted that in certain embodiments a cell is not sealed until after subsequent operations. In some cases, cap 918 or cell case 916 includes a safety device. For example, a safety vent or burst valve may be employed to open if excessive pressure builds up in the battery. In certain embodiments, a one-way gas release valve is included to release oxygen that has been released during activation of the positive material. Also, a positive thermal coefficient (PTC) device may be incorporated into the conductive pathway of cap 918 to reduce the damage that might result if the cell suffered a short circuit. The external surface of the cap 918 may used as the positive terminal, while the external surface of the cell case 916 may serve as the negative terminal. In an alternative embodiment, the polarity of the battery is reversed and the external surface of the cap 918 is used as the negative terminal, while the external surface of the cell case 916 serves as the positive terminal. Tabs 908 and 910 may be used to establish a connection between the positive and negative electrodes and the corresponding terminals. Appropriate insulating gaskets 914 and 912 may be inserted to prevent the possibility of internal shorting. For example, a Kapton™ film may be used for internal insulation. During fabrication, the cap 918 may be crimped to the cell case 916 in order to seal the cell. However, prior to this operation, electrolyte (not shown) is added to fill the porous spaces of the jelly roll.

A rigid case is typically used for lithium ion cells, while lithium polymer cells may be packed into flexible, foil-type (polymer laminate) cases. A variety of materials can be chosen for the cases. For lithium-ion batteries, Ti-6-4, other Ti alloys, Al, Al alloys, and 300 series stainless steels may be suitable for the positive conductive case portions and end caps, and commercially pure Ti, Ti alloys, Cu, Al, Al alloys, Ni, Pb, and stainless steels may be suitable for the negative conductive case portions and end caps.

Although the foregoing invention has been described in some detail for purposes of clarity of understanding, it will be apparent that certain changes and modifications may be practiced within the scope of the appended claims. It should be noted that there are many alternative ways of implementing the processes, systems and apparatus of the present invention. Accordingly, the present embodiments are to be considered as illustrative and not restrictive, and the invention is not to be limited to the details given herein.

All publications, patents, patent applications, or other documents cited in this document are incorporated by reference in their entirety for all purposes to the same extent as if each individual publication, patent application, or other document were individually indicated to be incorporated by reference for all purposes.

What is claimed is:

1. A method of fabricating a lithium ion electrode subassembly for use in a lithium ion cell, the method comprising:
receiving nanostructures comprising an electrochemically active material; and
depositing amorphous silicon and/or germanium over the nanostructures to electrically interconnect at least a portion of the nanostructures.

2. The method of claim 1, wherein the electrochemically active material is selected from the group consisting of silicon, germanium, and tin.

3. The method of claim 1, wherein the nanostructures comprise nanowires with an average aspect ratio of at least about 4.

4. The method of claim 3, wherein the nanowires have an average cross-section dimension of between about 1 nanometer and 2,000 nanometers in a fully discharged state.

5. The method of claim 3, wherein the nanowires have a length of at least about 2 micrometers in a fully discharged state.

6. The method of claim 1, wherein depositing the amorphous silicon and/or germanium comprises flowing a process gas containing silane into a Chemical Vapor Deposition (CVD) chamber.

7. The method of claim 6, wherein a concentration of silane in the process gas is between about 1% and about 20%.

8. The method of claim 1, wherein the nanostructures are maintained at an average temperature of between about 200° C. and 700° C. during depositing amorphous silicon and/or germanium.

9. The method of claim 1, wherein the nanostructures are attached to a substrate and wherein the substrate comprises one or more materials selected from the group consisting of copper foil, stainless steel foil, nickel foil, and titanium foil.

10. The method of claim 9, wherein at least about 10% of nanostructures are substrate rooted.

11. The method of claim 9, wherein at least a portion of the amorphous silicon and/or germanium is deposited on the substrate and provides additional mechanical support to the nanostructures and additional electrical connection between the nanostructures and the substrate.

12. The method of claim 9, wherein the nanostructures are attached to the substrate by a binder and wherein the binder is at least partially removed during depositing amorphous silicon and/or germanium.

13. The method of claim 1, further comprising compressing the nanostructures to electrically interconnect at least a portion of the nanostructures.

14. The method of claim 13, wherein compressing is performed while the nanostructures are maintained at a temperature of at least about 200° C.

15. The method of claim 13, wherein compressing is performed while passing an electrical current through a layer formed by the nanostructures.

16. The method of claim 13, wherein compressing is performed prior to depositing the amorphous silicon and/or germanium.

17. A lithium ion electrode subassembly for use in a lithium ion cell, the lithium ion electrode subassembly comprising:
nanostructures comprising an electrochemically active material; and
amorphous silicon and/or germanium deposited over the nanostructures and electrically interconnecting at least a portion of the nanostructures.

18. A lithium ion cell comprising:
nanostructures comprising an electrochemically active material; and
amorphous silicon and/or germanium deposited over the nanostructures and electrically interconnecting at least a portion of the nanostructures.

19. A method of fabricating a lithium ion electrode subassembly for use in a lithium ion cell, the method comprising:
receiving nanostructures comprising an electrochemically active material and forming an active layer, wherein at least 10% of the nanostructures are directly substrate rooted to a substrate; and
depositing an interconnecting material onto the active layer to electrically interconnect at least a portion of the nano structures.

20. The method of claim 19, wherein the interconnecting material comprises a metal containing material.

21. The method of claim 19, wherein the interconnecting material comprises one or more selected from the group consisting of copper, nickel, iron, chromium, aluminum, gold, silver, tin, indium, gallium, and lead.

22. The method of claim 19, further comprising treating the layer to electrically interconnect additional nanostructures and/or improve existing electrical connections.

23. The method of claim 22, wherein treating the layer comprises heating the layer to at least 200° C.

24. The method of claim 23, wherein treating the layer comprises exerting pressure on the layer.

25. The method of claim 22, wherein treating the layer comprises forming a metal silicide on interfaces of the nanostructures and the metal containing interconnecting material.

26. The method of claim 19, wherein the electrochemically active material is selected from the group consisting of silicon, germanium, and tin.

27. A method of fabricating a lithium ion electrode subassembly for use in a lithium ion cell, the method comprising:
receiving nanostructures comprising an electrochemically active material, wherein the nanostructures form a layer; and
passing an electrical current through the layer to bond nanostructures and to electrically interconnect at least a portion of the nanostructures.

28. The method of claim 27, wherein passing the electrical current is performed while the layer is compressed.

29. The method of claim 27, wherein passing the electrical current is performed while the nanostructures are maintained at a temperature of at least about 200° C.
